(19) United States
(12) Patent Application Publication
(10) Pub. No.: US 2020/0250779 A1
(43) Pub. Date: Aug. 6, 2020

(54) Worldwide Prior Art and Legal Representative Repository and System for Cooperation Between Worldwide National Patent Offices

(71) Applicants: ERICH LAWSON SPANGENBERG, PARIS (FR); DANIEL LAWRENCE BORK, EAST KINGSTON, NH (US); PASCAL ASSELOT, PARIS (FR); BRIAN JOSHUA BERMAN, LONG ISLAND CITY, NY (US)

(72) Inventors: ERICH LAWSON SPANGENBERG, PARIS (FR); DANIEL LAWRENCE BORK, EAST KINGSTON, NH (US); PASCAL ASSELOT, PARIS (FR); BRIAN JOSHUA BERMAN, LONG ISLAND CITY, NY (US)

(21) Appl. No.: 16/758,398

(22) PCT Filed: Nov. 16, 2018
(86) PCT No.: PCT/US18/61448

§ 371 Date: Apr. 23, 2020

Related U.S. Application Data
(63) Continuation of application No. 16/758,375.
(60) Provisional application No. 62/588,350, filed on Nov. 19, 2017.
(60) Provisional application No. 62/588,932, filed on Nov. 21, 2017.
(60) Provisional application No. 62/607,919, filed on Dec. 20, 2017.
(60) Provisional application No. 62/610,265, filed on Dec. 25, 2017.
(60) Provisional application No. 62/622,922, filed on Jan. 28, 2018.
(60) Provisional application No. 62/622,987, filed on Jan. 29, 2018.
(60) Provisional application No. 62/622,994, filed on Jan. 29, 2018.
(60) Provisional application No. 62/660,946, filed on Apr. 21, 2018.
(60) Provisional application No. 62/672,697, filed on May 17, 2018.
(60) Provisional application No. 62/685,299, filed on Jun. 15, 2018.
(60) Provisional application No. 62/685,937, filed on Jun. 16, 2018.
(60) Provisional application No. 62/685,960, filed on Jun. 16, 2018.
(60) Provisional application No. 62/689,241, filed on Jun. 24, 2018.
(60) Provisional application No. 62/695,002, filed on Jul. 7, 2018.
(60) Provisional application No. 62/695,126, filed on Jul. 8, 2018.
(60) Provisional application No. 62/696,357, filed on Jul. 11, 2018.
(60) Provisional application No. 62/575,610, filed on Oct. 23, 2017.
(60) Provisional application No. 62/576,516, filed on Oct. 24, 2017.
(60) Provisional application No. 62/577,253, filed on Oct. 26, 2017.
(60) Provisional application No. 62/579,172, filed on Oct. 31, 2017.
(60) Provisional application No. 62/579,347, filed on Oct. 31, 2017.
(60) Provisional application No. 62/582,976, filed on Nov. 8, 2017.

(51) Int. Cl. G06Q 50/18; G06F 16/27

(52) U.S. Cl. CPC G06Q 50/184; G06F 16/27

(57) ABSTRACT

Using the private blockchain, the present invention will permit simultaneous cooperation between multiple, worldwide Patent Offices when reviewing patent applications by having a single repository for 1. prior art submitted by the applicant; 2. prior art identified by the various examiners at the NPOs; and 3. third parties. All prior art for a given patent in examination is stored in one repository (such as provided by the present invention) and it is (at first) controlled by cooperating national patent Offices. The repository can be controlled by other parties that are not national patent Offices. Using the private blockchain, the present invention will permit a patent Owner or Applicant to select worldwide patent law firms to draft and prosecute a patent application in worldwide countries. The patent Owner or Applicant can select which countries he wants to file patent applications in. The patent Owner or Applicant can list specific requirements regarding the background/education/work experience for which patent attorneys should file his patent applications.

### PRIORITY CLAIMS

This application claims the benefit of U.S. Provisional Patent Application No. 62/588,350, filed Nov. 19, 2017. This application also claims the benefit of U.S. Provisional Patent Application No. 62/588,932, filed Nov. 21, 2017. This application also claims the benefit of International Patent Application Number PCT/US2018/56690, filed on Oct. 19, 2018, which claims the benefit of U.S. Provisional Patent Application No. 62/575,610, filed Oct. 23, 2017. This application also claims the benefit of International Patent Application Number PCT/US2018/56884, filed on Oct. 22, 2018, which claims the benefit of U.S. Provisional Patent Application No. 62/576,516, filed Oct. 24, 2017. This application also claims the benefit of International Patent Application Number PCT/US2018/57062, filed on Oct. 23, 2018, which claims the benefit of U.S. Provisional Patent Application No. 62/577,253, filed Oct. 26, 2017, U.S. Provisional Patent Application No. 62/579,172, filed Oct. 31, 2017, and U.S. Provisional Patent Application No. 62/579,347, filed Oct. 31, 2017. This application also claims the benefit of International Patent Application Number PCT/US2018/59174, filed on Nov. 5, 2018, which claims the benefit of U.S. Provisional Patent Application No. 62/582,976, filed Nov. 8, 2017. This application also claims the benefit of U.S. Provisional Patent Application No. 62/607,919, filed Dec. 20, 2017. This application also claims the benefit of U.S. Provisional Patent Application No. 62/610,265, filed Dec. 25, 2017. This application also claims the benefit of U.S. Provisional Patent Application No. 62/622,922, filed Jan. 28, 2018. This application also claims the benefit of U.S. Provisional Patent Application No. 62/622,987, filed Jan. 29, 2018. This application also claims the benefit of U.S. Provisional Patent Application No. 62/622,994, filed Jan. 29, 2018. This application also claims the benefit of U.S. Provisional Patent Application No. 62/660,946, filed Apr. 21, 2018. This application also claims the benefit of U.S. Provisional Patent Application No. 62/672,697, filed May 17, 2018. This application also claims the benefit of U.S. Provisional Patent Application No. 62/685,299, filed Jun. 15, 2018. This application also claims the benefit of U.S. Provisional Patent Application No. 62/685,937, filed Jun. 16, 2018. This application also claims the benefit of U.S. Provisional Patent Application No. 62/685,960, filed Jun. 16, 2018. This application also claims the benefit of U.S. Provisional Patent Application No. 62/689,241, filed Jun. 24, 2018. This application also claims the benefit of U.S. Provisional Patent Application No. 62/695,002, filed Jul. 7, 2018. This application also claims the benefit of U.S. Provisional Patent Application No. 62/695,126, filed Jul. 8, 2018. This application also claims the benefit of U.S. Provisional Patent Application No. 62/696,357, filed Jul. 11, 2018, each of which is incorporated herein by reference.

### FIELD OF THE INVENTION

This invention deals with worldwide patent Offices conducting patentability searches as well as hiring worldwide law firms.

### BACKGROUND OF THE INVENTION

For quite some time, patent laws and policies varied widely across countries. With the recent formation of the World Trade Organization (WTO), however, a process of convergence in patent systems has occurred. Not only have nations, particularly developing economies, adopted new patent laws, but according to the Trade Related Intellectual Property Rights (TRIPs) Agreement, members of the WTO are expected to ratify further changes that will harmonize patent systems even more. In addition to the WTO proposals, the United Nation's World Intellectual Property Organization (WIPO) has recommended additional proposals of its own to make patent laws across countries (particularly, procedural matters) much more uniform. These proposals are outlined in the WIPO's Patent Law Treaty (PLT).

However, despite these advancements, inventors are forced to overcome a cumbersome and expensive process when it comes to global patenting. The inventor must select from various countries with various filing fees. After making risky and critical decisions, the inventor must select from a slew of foreign prosecution firms. Finally, the inventor is faced with various prosecution styles from various patent offices throughout the world.

These risks are causing tremendous strain in the patent field. Countries are giving inconsistent results for patentability that is raising the costs of business. A solution that allows for a truly global economy must be created.

### SUMMARY OF THE INVENTION

The logic of why patent systems exist is discussed extensively in the literature. It is therefore best to focus on a few clarifying points. First, in the absence of a patent system, markets for ideas would be “missing” due to the public good nature of knowledge. A patent system therefore creates a market which would otherwise not exist. The cost, however, is that the market in question will not be competitive, but monopolistic. The innovator might not otherwise be able to recoup her upfront research and development (R&D) costs, given how relatively cheaply the output can be reproduced at competitive prices. Thus, a tradeoff exists between technology creation and diffusion: patent systems must provide on the one hand adequate incentives for technology creation (in the form of positive economic profits) and on the other hand opportunities for competitive, efficient diffusion.

This description of the patent process sometimes creates a few misconceptions. The first is that a patent makes a firm (or inventor) a monopolist, in the traditional sense of a single firm in an industry. Rather, the patent gives the holder the right to exclude others from using the new idea commercially; it does not allow the holder to exclude other firms from the industry in which it serves. A second misconception is that the tradeoff is between technology creation and knowledge diffusion; rather it is between the former and the diffusion (or supply) of output embodying the new knowledge. Patents do not restrict the diffusion of knowledge; on the contrary, they help diffuse it. The reason is that, in exchange for patent protection, inventors must disclose their new knowledge (either some time during the application or after a patent is granted). A third misconception is that the patent holder will manufacture an output based on the idea. Patents indicate recognition of the novelty, nonobviousness, and usefulness (e.g. industrial applicability) of new ideas. T hey are not contracts or commissions of work. Of course, some nations can require manufacturing (called working requirements) or revoke a patent if the holder fails to do so. Other nations let the patent holder choose whether and when to manufacture.

A fourth misconception is that because the inventor recouped her upfront R&D costs in her own domestic market, there is no need to provide her with exclusive protection in foreign markets. Thus, the output should be competitively supplied in foreign markets, especially in the less developed. First, inventors may seek global markets precisely because their kinds of inventions require a larger world market to help recoup their costs.3 Secondly, knowing that they can serve a larger world market influences the scale of inventors' research projects. If it is only possible to recoup R&D costs from the (smaller) domestic markets, inventors may choose smaller than potential investments in R&D. This would be a loss to global welfare to the extent that the potential technology could have been useful in various national economies. Finally, global patent protection is increasingly necessary in a world where imitation risks are greater and more widespread (geographically).

The current process of patenting on a global scale is cumbersome and expensive. Prior to even seeking patent protection, an inventor must first decide whether to obtain a patent or keep the invention a trade secret. The inventor of course risks being imitated and not being able to claim damages, but some nations do provide trade secret protection. On the other hand, while many nations provide trade secret protection, some do not. One noticeable country that does not provide it is Japan. In the U.S., trade secrets are protected by state, not federal, laws. In many instances, trade secret protection does not protect against another inventor independently developing the invention and patenting it, or against reverse engineering.

As such, for each potential country, an inventor must compare the benefits and costs of applying for a patent in that country. The benefits depend on market size, imitation risk, and how well patent rights are protected. The costs include official filing fees, agents' fees, and translation costs. The costs are typically lower in countries where translation is not necessary and high where it is; for example, Japan and Europe.

Given these costs and benefits, the profit-maximizing inventor's decision is to patent in a particular country if the rise in present value profits in that country due to patent protection exceeds the cost, else the inventor chooses to keep the invention a secret. Having decided to apply for a patent, the inventor faces the test of priority: who gets to apply for a patent for this specific invention? Is another application pending? Within each market, it is generally the first to file who gets priority. In the U.S. and Philippines, it is the first to invent. If the inventor files in several countries, priority is also governed by international treaties (provided the countries are signatories). The Paris Convention allows inventors in member countries up to 12 months to file an application in other member countries after first filing in one member country (usually the country of origin of the inventor). The inventor thus reserves that initial filing date, for 12 months, for purposes of establishing who was first to file. A few other international treaties should be mentioned. The Patent Cooperation Treaty (PCT) permits inventors to file a single “international” patent application in as many of the member nations they wish to designate. The PCT establishes priority, as before with the Paris Treaty, on the basis of the earliest domestic filing. The filing of a PCT application also extends the deadline for filing foreign applications in member nations to 20 months (i.e. adds 8 months to the 12 from the Paris Treaty). Some cost savings are realized by the inventor with the PCT application, for example a reduction in search costs. Eventually the inventor must file, and incur the necessary costs of, separate national patent applications in each of the designated countries within 20 months, or else forfeit patent rights in those countries. Countries that are members of PCT II, however, may provide a further 10 month extension, giving a total extension time of 30 months, at the end of which applicants must go to the national phase (i.e. file in the separate jurisdictions) or else forfeit patent rights.

A single international filing procedure is also available to inventors who apply in member nations of the European Patent Office (EPO). As the EPO is part of the PCT and Paris Conventions (i.e. treated as one bloc member), the previous priority rules and extension privileges continue to apply. The advantages of a single EPO application are: a) language, as the application can be made in any one of the three languages (English, French, or German), but upon grant, it must be translated into the native languages of the countries designed in the application; b) a single, centralized examination; c) filing-cost savings (provided coverage is sought in at least 3 member nations). A disadvantage of the EPO application is that the applicant puts all her “eggs in one basket.” If the EPO rejects the patent application, the applicant cannot then apply directly to national patent offices. While the EPO patent has effect in each of the jurisdictions designated, it is enforced individually within the national jurisdictions.

Despite these systems, an inventor faces significant expenses in prosecution of his application. These include both filing fees, translation fees, and legal fees. With respect to Legal fees, it is expensive to have one law firm, such as located in your domestic, home country, oversee and pick worldwide, foreign law firms to file patent applications. Frequently, the domestic law firm might not even review at all the legal work conducted by the foreign attorneys. However, the domestic law firm charges an additional legal fee for overseeing all of the foreign law firms. For example, an inventor files a patent application in the US with law firm A. Then law firm A picks 10 foreign law firms to file patent applications in those 10 foreign countries. Sometimes, law firm A will not even review any of the legal work of the 10 foreign law firms. However, law firm A bills and invoices for reviewing, revising, monitoring, and overseeing the foreign law firms.

When foreign law firms file patent applications in foreign languages, the patent law firm in the home domestic country always charges a fee for monitoring the foreign law firms. However, it is common at many law firms that the patent attorney in the home domestic country does not spend any time reviewing any of the patent legal work of the foreign attorney. Instead, the patent attorney of the home domestic country typically relies on and expects the foreign attorney understands the laws and regulations in their country. Also, the patent attorney in the home domestic country is not incentivized to review the English translation of patent applications and responses filed in foreign languages, since the patent attorney cannot bill/invoice too much money for reviewing and monitoring work of foreign attorneys. Therefore, many patent attorneys in the home domestic country simply ignore the English translations of draft patent applications and draft amendments and draft responses to be filed in foreign languages in foreign countries. Many patent attorneys in the home domestic country simply approve the foreign attorneys' draft patent applications, draft responses to Office Actions, and draft amendments to Office Actions without ever looking at the draft English translations. Basically, the domestic patent attorneys are currently billing for legal services for 1. reviewing and 2. revising draft patent applications (and responses to office actions and amendments to office actions) in foreign countries, when in fact they frequently never conducted these legal services.

In addition to the legal fees, the filing fees and hurdles associated with a patent are extreme. In the patent application process, it is important to determine priority (who is the first to qualify for a patent) and patentability (whether the invention is novel, and whether the subject matter of the patent is not restricted). If the invention is not completely novel (in the sense that it was revealed publicly prior to the application), a grace period or exception might apply. During the application process, it is necessary to incur fees, undergo examination, and determine when public disclosure is to occur. Once a patent is granted, if at all, the inventor is allowed a certain duration of protection; there may also be third-party opposition to the grant, or restrictions such as a working requirement or compulsory licensing to third-parties. If global patent protection is sought, it matters whether nations are members of international treaties affecting priority, fees, and national treatment.

Currently, patent Examiners in worldwide Patent Offices do not have access to the prior art in patent families for the same patent application filed in other countries. An inventor may be granted a priority patent in one country, but rejected in another. Moreover, the risks associated with failing to apply in any one country can be so high, that an inventor must resolve himself to the fact that certain countries will be rejected.

The present invention seeks to provide a method and system of combining patent data and connecting examiners and law firms on one platform. Previously this was impossible because it would require massive collaboration and secure servers.

The present invention proposes a method of solving the issues associated with the patent ecosystem and the IP system as a whole, is to use a decentralized approach via blockchain technology. Blockchain technology (sometimes simply referred to as a blockchain) was developed and has been used in certain digital currency implementations. An example implementation and corresponding blockchain techniques are described in a 2008 article by Satoshi Nakamoto, called “Bitcoin: A Peer-to-Peer Electronic Cash System,” the entire contents of which are hereby incorporated by reference. With that being said, in certain embodiments discussed herein, the blockchain may be privately hosted (e.g., where all member nodes are run and provided by the same entity or a controlled group of entities). In certain example embodiments, the blockchain may be a distributed blockchain, such as the one provided by the bitcoin network. Thus, the term blockchain as used herein is not confined to the so-called blockchain that is only used for the bitcoin cryptographic currency.

The blockchain is a data structure that stores a list of transactions and can be thought of as a distributed electronic ledger that records transactions between source identifier(s) and destination identifier(s). Every transaction is “to” a destination identifier that is associated with a public/private key pair. In creating a new transaction, outputs from other, prior transactions that are to the “from” address (which may be multiple different addresses derived from the same private key) are used as inputs for this new transaction. The new transaction is then encumbered with the public key associated with the “to” destination identifier. In other words, outputs from prior blockchain transactions are used as inputs for new transactions that are then signed using the public key associated with the destination address. The new blockchain transaction is then submitted to the blockchain. Once on the blockchain multiple such transactions are bundled into a block and the block is linked to a prior block in the “blockchain.” Computer nodes of the distributed system then maintain the blockchain and validate each new block (along with the transactions contained in the corresponding block). The techniques described herein make use of blockchain technology to address one or more problems with the conventional database systems

Blockchain technology holds great promise for a range of industries and business cases, including the patent asset class. That is because a Blockchain can be viewed as a type of shared database, the contents of which are verified and agreed upon by a network or independent actors. For a new piece of data (such as the owner of a newly issued patent) to be added to the Blockchain, the independent verifiers must come to consensus on its validity.

Because each new set of transactions (a “block”) is cryptographically linked to the previous block, it is extraordinarily difficult to change data stored in a Blockchain and any such change would be readily detectable. Thus, blockchains are widely considered to be immutable and thus can serve as a record of proof of ownership.

When transacting in a Blockchain platform, each user makes use of a public address (needed for other actors in the network to send a transaction to that user), and a cryptographically paired “private key.” Private keys are used to sign transactions digitally, a form authentication to ensure that a given user has genuinely generated a transaction.

Blockchain is a relatively new technology. The first “real world” implementations of Blockchain, Bitcoin, envisioned by Satoshi Nakamoto launched in 2009. The Ethereum Blockchain was released in 2015. In addition to the distributed ledger capability of the Bitcoin Blockchain, the Ethereum Blockchain allows so-called “smart contracts,” which are programs stored in the Ethereum Blockchain that can act autonomously to execute sophisticated transactions.¹ ¹ “Ethereum Whitepaper,” http://github.com/ethereum/wiki/white-paper, 2016

Blockchain data transfer is currently considered one the most secure technologies for digital asset transfer due to its distributed nature and use of sophisticated cryptography. Smart contracts, therefore, offer a potential solution for the management of patent transactions via the introduction of a universal, distributed ledger that does not require trust in a single third party.

The Bitcoin blockchain is limited to sets of simple information and scripts such as transaction details, and conditioning a transaction on a minimum number of signatories. It was therefore argued that for a virtual currency to truly revolutionize trade it must also provide built-in means for facilitating complex contracts and deals with the currency.

Project Ethereum builds upon Bitcoin. Not only does it allow decentralized data storage in its blockchain, Ethereum also allows storing program code on its blockchain and running it concurrently by any number of network members. By predicating release of funds upon verifiable occurrences, Ethereum enables smart contract functionality.

Basically, a network member uploads a computer program written in one of several permitted languages to the blockchain. The member may then condition the release of an amount of ETH (the currency underlying Ethereum) upon reaching the end of this program. Various network members thereafter run the program concurrently and reach a consensus on the resulted output.

The scripting languages in Ethereum or the IBM Hyperledger are Turing complete as they can implement any logic rules and initiate any calculations available.

This feature allows any member to issue and trade with a custom virtual currency upon the Ethereum network. For the sake of clarity, a custom virtual currency issued and based upon another virtual currency is referred to as a Token. A Token may have various uses. While a certain Token will represent money, another Token will represent club member points or frequent flyer points. Tokens may be traded for ETH or for any other commodities and Tokens via the Ethereum or the IBM Hyperledger network.

Before Ethereum or the IBM Hyperledger, a person was required to launch a new blockchain utilizing custom user clients and mining algorithm, in order to issue a custom decentralized virtual currency. The emergence of the Ethereum or the IBM Hyperledger network allows easy issuance of Tokens with minimal setup.

It should be mentioned that after Ethereum, several other virtual currency networks implementing smart contracts were established. Prominent examples include the IBM Hyperledger, Lisk and RootStock.

The proposed method envisions platform on a decentralized network, which connects examiners with prior art, inventors with law firms, and a new system by which to approach the global patenting process.

### BRIEF DESCRIPTION OF THE DRAWINGS

The various embodiments are illustrated by way of example, and not by way of limitation, in the figures of the accompanying drawings in which:

FIG. 1 is an illustration depicting an exemplary operating environment including one or more user computers, computing devices, or processing devices, which can be used to operate a client, such as a dedicated application, web browser is shown.

FIG. 2 is another illustration depicting an exemplary operating environment including a computer system with various elements as shown.

FIG. 3 is an illustration of one aspect of the present invention.

### DETAILED DESCRIPTION OF THE INVENTION

Currently, most inventors can't afford to file patent applications individually in each country, since that is way too expensive to hire patent attorneys in each country. Therefore, this worldwide patent application seeks to provide a cost effective approach to global patenting. Therefore, this worldwide patent will encourage people to seek patent protection worldwide.

Specifically, using the private blockchain, the present invention will allow for the simultaneous cooperation between multiple, worldwide National Patent Offices (“NPOs”). In one embodiment, when reviewing patent applications by having a single repository for 1. prior art submitted by the applicant; 2. prior art identified by the various examiners at the NPOs; and 3. third parties. All prior art for a given patent in examination is stored in one repository (such as provided by the present invention) and it is (at first) controlled by cooperating national Patent Offices. The repository can be controlled by other parties that are not national Patent Offices. The invention can also be on/utilize the public blockchain. The invention is not required to be on/utilize the blockchain at all. It is not required that the invention be on the blockchain. The invention can utilize a combination of public blockchain and private blockchain.

In one embodiment, the patent applicant can cite art in the present invention, and all of the examiners at all the NPOs can see the art in one spot. As continuations are filed, it would be simple to access the same records. Patent Examiners can also cite art in the present invention. Whenever any patent Examiner cites prior art to a patent family, then that art will also be added to the repository.

In one embodiment, third parties can cite art to a patent family, and the art will also be added to the repository. The present invention will have measures to reduce spam, by charging the third party one (1) token to upload prior art. If the third party prior art citation is credible, then he can receive up to ten tokens. For example, a competitor could pay out the ten 10 tokens. For example, for a patent application filed by Apple, Samsung might voluntarily offer to pay out 10 tokens for that patent application. Samsung could choose whether the 10 tokens all go to one person (either the patent Examiner or a third party), or if the 10 tokens should be paid out to 10 different people with 1 token going to each person.

In one embodiment, patent Examiners can save their patent search strategies. That way, other people can review, modify, and improve their search strategies. For example, some Examiners in other countries could use the same search strategies, after translating the customized search queries into their native home country languages.

In one embodiment, third parties could also use social networking/collaboration features to assist each other with their crowdsourced patentability searches.

In one embodiment, the system will also be available for Amendments to the claims filed during the prosecution of a patent application. This system will also be available for issued/granted patents. Therefore, links to the file histories of the patent applications will be made available from the platform of the present invention.

In another embodiment, all patent Examiners and third parties will be allowed to write comments on why they think certain prior art is related and similar to the invention, claims, specification, etc. The Applicant will also be allowed to respond why he feels certain prior art is not related to his invention, and does not actually read on the claims.

In a further embodiment, the worldwide patent offices can work together during the search, there will be a worldwide patent. All worldwide Patent Offices would be allowed to submit prior art during the patent application process. Since all worldwide Patent Offices have the option to cite prior art during the pendency of a patent application, it is fair and ethical to create a worldwide patent. The language of the worldwide patent could be in one language, such as English. There could be multiple official languages for the worldwide patent. This will save patent Owners money from having to hire different patent attorneys in individual countries to file and prosecute the patent application. This will help prevent individual countries from issuing broad patents, that never should have been issued/granted. Many people claim a very big problem is that some Patent Offices allow broad patents. This worldwide patent will help solve that problem.

An example embodiment depicting the process is as follows:
1. Applicant A files a patent application in country B.
2. Patent Examiner B in country C uploads the patent application to the present invention's private blockchain.
3. Patent Applicant A cites prior art D, E, and F in country B.
4. Patent Applicant A can put prior art D, E, and F into the present invention's private blockchain.
5. Patent Examiner B can put prior art D, E, and F into the present invention's private blockchain.
6. Patent Examiner G in country H can put prior art I into the present invention's private blockchain.
7. Third party J can put prior art K into the present invention's private blockchain. Third party J pays one (1) coin in order to be allowed to put prior art K into the present invention's private blockchain.
8. Third party J and/or patent Examiner L can receive 10 coins for citing the best prior art.

In one embodiment, the platform embodiment of the present invention platform can be used by both the patent Owner and the Applicant, to directly contact foreign patent law firms. The platform embodiment contains a database of worldwide patent law firms; worldwide patent attorneys; and worldwide patent agents.

One embodiment allows the patent Owner or Applicant to manually select a foreign law firm for each individual country.

Another embodiment allows the patent Owner or Applicant to not select any foreign law firms for any countries. Instead, the present invention Platform can automatically choose a foreign law firm for each country.

Another embodiment allows the patent Owner or Applicant to choose some foreign law firms, and have the present invention Platform choose a foreign law firm for the remaining countries.

In one embodiment, the patent Owner or Applicant chooses all of the foreign countries that he wants to file patent applications. The patent Owner or Applicant has the option of not selecting any foreign countries. Instead, the patent Owner or Applicant can select that the option of having the platform embodiment to choose which foreign countries to file patent applications in.

In another embodiment, the patent Owner or Applicant can choose the patent attorney in their domestic country to pick which foreign countries to file patent applications in. The present invention can also automatically select which foreign countries to file patent applications in. Alternatively, the present invention can allow a patent attorney (or non-patent attorney) to select which foreign countries to file patent applications in.

As an example, in one embodiment, the platform of the present invention can allow the patent owner or applicant to answer basic questions regarding which countries he wants to sell, license, manufacture, make, and use his invention in. The platform embodiment can ask the patent owner or applicant how much anticipated/expected sales does he expect in each foreign country. The platform embodiment can ask for any information about plans for the invention's products and/or services to be used in each foreign country, in order to determine which foreign countries to file patent applications in (such as by machine learning, artificial intelligence, predictive analytics, etc.). This information also helps the patent attorney in the home domestic country manually decide which foreign countries to file patent applications in. This information can also be used by the patent attorney in each foreign country to manually decide whether to file a patent application in each foreign country.

In another embodiment, third parties and the public can use crowdsourcing to help vote and decide which foreign countries to file patent applications in. Third parties and the public can use crowdsourcing to help vote and decide when to respond to Office Actions and when to abandon patent applications. Patent Attorneys in different countries can assist each other with responding to Office Actions, to help with legal arguments, Amendments, and Response to Office Actions. Patent attorneys and third parties and the public can use crowdsourcing to help vote and decide which foreign law firms and which foreign patent attorneys should handle filing the patent application. For example, they might factor in the technology area, the experience of the attorney, the reputation of the law firm, etc.

In one embodiment, the patent Owner or Applicant can select or state criteria for when the patent attorney should respond to the Patent Office and when the patent attorney should abandon the application. For example, the patent Owner or Applicant can state to only spend a maximum of $50,000 for that country, and then to give up and abandon that patent application in that specific foreign country. The patent Owner or Applicant can also select pre-existing criteria, or manually type criteria that he wants. For example, he can state that he only wants big law firms (over 500 total attorneys) handling his legal work filing his patent applications. He can state he only wants an attorney with a PhD in electrical engineering filing his patent applications. He can state he only wants an attorney with at least ten (10) years of experience filing his patent applications. He can state he only wants a female patent attorney filing his patent applications.

In one embodiment, the patent Owner can state he only wants the patent attorney filing a maximum number (such as four (4)) of responses to Office Actions to each countries' Patent Office before abandoning the patent application. The patent Owner can state he only wants the patent attorney spending a certain amount of time (such as four years from filing the patent application, or three years from the first Office Action from that countries' Patent Office, or by a set deadline such as by Jan. 1, 2020) trying to get an issued/granted patent. Otherwise, the patent attorney should give up and abandon the patent application.

In one embodiment, the patent Owner can state he first wants a narrow issued patent, before filing continuation applications. The patent Owner can state he only wants a broad patent. The patent Owner can state he just wants any issued patent, regardless of what is included in the claim. The patent Owner might not care what is included from the specification in the issued/granted claim. The patent Owner might require that only certain inventive concepts such as from one or two key features in specific paragraphs be in the issued/granted patent. If the patent Examiner rejects those features, then the patent Owner might not want the patent attorney wasting any additional time or money trying to get an issued/granted patent for any of the other features in the specification.

In one embodiment, the platform created in furtherance of this invention can also be used for filing trademark applications, copyright applications, patent litigation, trademark litigation, copyright litigation, all areas of law, all legal services, all non-legal services, all professional services, all administrative services, purchasing any products, selling any products, licensing any products, transacting any products, etc.

In another embodiment of the present invention, a social networking and collaboration feature is included. There will be communications capabilities so patent attorneys in different countries can talk to one another—privately or publicly. There will be a feature, wherein all of the worldwide patent Attorneys can easily collaborate with each other, including instant messenger, video conference, phone, email, live chat, etc. A patent Attorney could pay money, coins or tokens used as internal currency within the present invention, or currency (or any other intangible or tangible good) to patent attorneys (or any other people located in foreign countries or in his own domestic country) that provide advice for patent prosecution in his country.

In one embodiment, the patent Owner or Applicant can pay in advance money stored on the platform embodiment of the present invention. Then, whenever money is due to the patent attorneys in foreign countries, the platform can pay the money out to the foreign and domestic patent law firms. Any currency can be used. Coins or tokens exclusive to the present invention can also be used. The patent Owner or Applicant can pay in his local currency. The platform can pay out the money in the local currency of each foreign country. The platform can use arbitrage when paying out in the local currency of each foreign country's local currency. Any cryptocurrency (such as Ethereum or Bitcoin) can also be used. No cryptocurrency is required to be used in this invention.

In another embodiment, the patent Owner or Applicant is not required to pay in advance or store money (or cryptocurrency or coins/tokens) on the platform embodiment of the present invention. Instead, the patent Owner can wait until after the legal work is conducted and after the patent attorney submits an invoice, before the patent Owner pays money to the platform.

In another embodiment, money, digital currency, or any other tangible or intangible goods can be retrieved directly from the patent Owner's bank account or deposit account or any other checking account/savings account/cryptocurrency account/cryptocurrency wallet/cryptocurrency exchange, digital exchange, digital asset broker, or from any other place that patent Owner has money, digital currency, or any other tangible or intangible goods stored. The funds can be automatically retrieved from patent Owner's account when money is owed/due to the patent attorney. The platform embodiment could first require patent Owner to authorize the payment.

The patent Owner or Applicant can rank and also provide comments and feedback regarding the work product of the patent law firms. The patent law firms can put upload their fee schedules on the platform.

In another embodiment, third parties could also use social networking and collaboration features to assist the patent Owner or Applicant with patent prosecution. Third parties could recommend which patent law firms to use.

In another embodiment, third parties could also use social networking and collaboration features to assist the patent Attorneys with patent prosecution. Third parties could assist the patent law firms with patent prosecution, such as strategies.

The present invention also includes a crowdsourcing feature for response to patent and trademark Office Actions. A patent attorney can prepare a draft response to an Office Action from their country's Patent Office. There can be a crowdsourced feature wherein other patent attorneys at other law firms, or any third parties who are not required to be patent attorneys, or even the Applicant, can review and respond to the draft response. The other patent attorneys and third parties can all provide feedback to the draft Amendment and draft response to the Patent Office's Office Action.

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

In one embodiment, the present invention contains a method of transactions wherein all fees, payments, purchases, and services are transacted using virtual currency, or cryptocurrency. The Network can further reward various stakeholders for participation within the network using the same cryptocurrency tokens. Each token can be traded or transacted using various systems and converted to FIAT currency. Such a system is applicable as a blockchain network.

A block chain or blockchain is a distributed database that maintains a list of data records, the security of which is enhanced by the distributed nature of the block chain. A block chain typically includes several nodes, which may be one or more systems, machines, computers, databases, data stores or the like operably connected with one another. In some cases, each of the nodes or multiple nodes are maintained by different entities. A block chain typically works without a central repository or single administrator. One well-known application of a block chain is the public ledger of transactions for cryptocurrencies such as used in bitcoin. The data records recorded in the block chain are enforced cryptographically and stored on the nodes of the block chain.

A block chain provides numerous advantages over traditional databases. A large number of nodes of a block chain may reach a consensus regarding the validity of a transaction contained on the transaction ledger.

The blockchain typically has two primary types of records. The first type is the transaction type, which consists of the actual data stored in the block chain. The second type is the block type, which are records that confirm when and in what sequence certain transactions became recorded as part of the block chain. Transactions are created by participants using the block chain in its normal course of business, for example, when someone sends cryptocurrency to another person), and blocks are created by users known as “miners” who use specialized software/equipment to create blocks. In some embodiments, the block chain system disclosed, SS the number of miners in the current system are known and the system comprises primary sponsors that generate and create the new blocks of the system. As such, any block may be worked on by a primary sponsor. Users of the block chain create transactions that are passed around to various nodes of the block chain. A “valid” transaction is one that can be validated based on a set of rules that are defined by the particular system implementing the block chain. For example, in the case of cryptocurrencies, a valid transaction is one that is digitally signed, spent from a valid digital wallet and, in some cases, that meets other criteria.

In one embodiment, the Network is made up of a plurality of nodes, each node connected to another node in the plurality of nodes, having the ability to pass data to each of the connected plurality of nodes. At least one node of the plurality of nodes is connected to an existing blockchain. Using this existing blockchain the, decentralized transactions can take place.

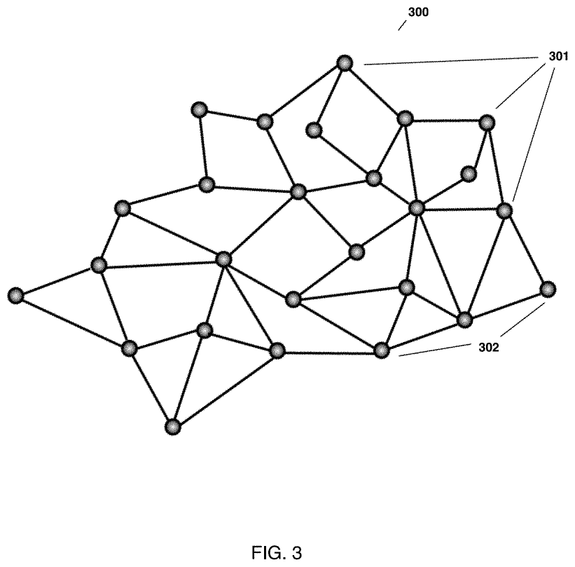

FIG. 3 depicts one aspect of the present invention. Specifically, the illustration shows the interconnection of each node 301 in a distributed decentralized network 300. In accordance with the preferred embodiment of the present invention, each node 301 in the distributed network 300 is directly connected to at least two other nodes 302. This allows each node 301 to transact with at least one other node 301 in the network.

In one embodiment, each transaction (or a block of transactions) is incorporated, confirmed, verified, included, or otherwise validated into the blockchain via a consensus protocol. Consensus is a dynamic method of reaching agreement regarding any transaction that occurs in a decentralized system. In one embodiment, a distributed hierarchical registry is provided for device discovery and communication. The distributed hierarchical registry comprises a plurality of registry groups at a first level of the hierarchical registry, each registry group comprising a plurality of registry servers. The plurality of registry servers in a registry group provide services comprising receiving client update information from client devices, and responding to client lookup requests from client devices. The plurality of registry servers in each of the plurality of registry groups provide the services using, at least in part, a quorum consensus protocol.

As another example, a method is provided for device discovery and communication using a distributed hierarchical registry. The method comprises Broadcasting a request to identify a registry server, receiving a response from a registry server, and sending client update information to the registry server. The registry server is part of a registry group of the distributed hierarchical registry, and the registry group comprises a plurality of registry servers. The registry server updates other registry servers of the registry group with the client update information using, at least in part, a quorum consensus protocol.

As another example, a computer-readable medium comprising computer executable instructions for causing a client device to perform a method for device discovery and communication is provided, the method comprising broadcasting a request to identify a registry server, receiving a response from a registry server, and sending client update information to the registry server. The registry server is part of a registry group of the distributed hierarchical registry, where the registry group comprises a plurality of registry servers. The registry server updates other registry servers of the registry group with the client update information using, at least in part, a quorum consensus protocol.

In some embodiments, the system is further able to conserve network and computing resources by securely storing information associated with user data, preventing potential malicious activity involving such information, conserving bandwidth, memory, and computation resources

A digital wallet is software and hardware (or specifically designed hardware) that allows an individual to make electronic commerce transactions that use, a blockchain. The digital wallet is a data structure that can include a private key (e.g., that is only known to the holder of the wallet) and a series of identifiers (sometimes called wallet identifiers, blockchain identifier, or walletIDs herein) that have been generated based on the private key. These identifiers are used to allow other users to “send” transactions, which are recorded on the blockchain, to that identifier. For example, the above novation process creates two blockchain transactions for a trade between Publisher (“Party A”) and the distributed decentralized network administrator (“Party B”). A first blockchain transaction may be from the wallet of party A to the wallet of the Party B. A second blockchain transaction may be from the wallet of the Party B to a wallet of party A. These transactions may be separately generated and submitted to the blockchain. Alternatively, the blockchain may only have one “wallet” that is being used for interacting with the blockchain. Other types of implementations may also be possible (e.g., where different parties, or their respective computer systems, use their own keys for a central blockchain). In certain embodiments, the wallets may be centrally managed by the distributed decentralized network computer system that the parties associated with the trade. However, the transactions recorded to the blockchain may still be signed by or otherwise associated with the individual wallets of the patent stakeholders.

A detailed description of one or more embodiments of the invention is provided above along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

The units described above can be implemented as software components executing on one or more general purpose processors, as hardware such as programmable logic devices and/or Application Specific Integrated Circuits designed to perform certain functions or a combination thereof. In some embodiments, the units can be embodied by a form of software products which can be stored in a nonvolatile storage medium (such as optical disk, flash storage device, mobile hard disk, etc.), including a number of instructions for making a computer device (such as personal computers, servers, network equipment, etc.) implement the methods described in the embodiments of the present invention. The units may be implemented on a single device or distributed across multiple devices. The functions of the units may be merged into one another or further split into multiple sub-units.

The methods or algorithmic steps described in light of the embodiments disclosed herein can be implemented using hardware, processor-executed software modules, or combinations of both. Software modules can be installed in random-access memory (RAM), memory, read-only memory (ROM), electrically programmable ROM, electrically erasable programmable ROM, registers, hard drives, removable disks, CD-ROM, or any other forms of storage media known in the technical field.

Persons of ordinary skill in the art are able to understand that all or portions of the steps in the embodiments described above may be realized using programs instructing the relevant hardware, and said programs can be stored on computer-readable storage media, such as a read-only memory, hard disk or compact disc. Optionally, all or portions of the steps of the embodiments described above may also be realized using one or multiple integrated circuits. Accordingly, the various modules/units contained in the embodiments above may also be realized in the form of hardware or software function modules. Thus, the present application is not limited to any specific combination of hardware and software.

The present application may have a variety of other embodiments and, without departing from the spirit and substance of the present application, persons skilled in the art may produce a variety of corresponding changes and modifications based on the present application, but these corresponding changes and modifications shall all fall within the scope of protection of the claims of this application.

Although the foregoing embodiments have been described in some detail for purposes of clarity of understanding, the invention is not limited to the details provided. There are many alternative ways of implementing the invention. The disclosed embodiments are illustrative and not restrictive.

While the invention has been described in detail and with reference to specific embodiments thereof, it will be apparent to those skilled in the art that various changes and modifications can be made therein without departing from the spirit and scope thereof. Thus, it is intended that the present invention cover the modifications and variations of this invention provided they come within the scope of the appended claims and their equivalents.

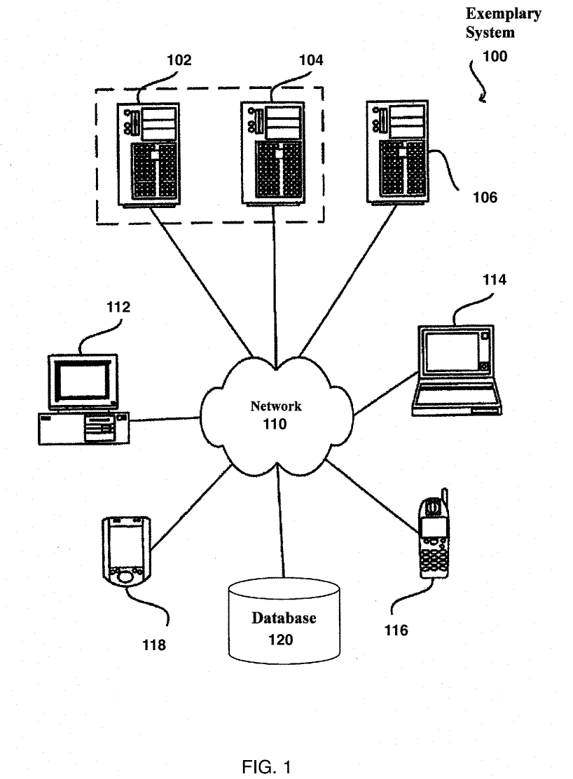

FIG. 1 is a block diagram illustrating components of an exemplary operating environment in which embodiments of the present invention may be implemented. The system 100 can include one or more user computers, computing devices, or processing devices 112, 114, 116, 118, which can be used to operate a client, such as a dedicated application, web browser, etc. The user computers 112, 114, 116, 118 can be general purpose personal computers (including, merely by way of example, personal computers and/or laptop computers running a standard operating system), cell phones or PDAs (running mobile software and being Internet, e-mail, SMS, Blackberry, or other communication protocol enabled), and/or workstation computers running any of a variety of commercially-available UNIX or UNIX-like operating systems (including without limitation, the variety of GNU/Linux operating systems). These user computers 112, 114, 116, 118 may also have any of a variety of applications, including one or more development systems, database client and/or server applications, and Web browser applications. Alternatively, the user computers 112, 114, 116, 118 may be any other electronic device, such as a thin-client computer, Internet-enabled gaming system, and/or personal messaging device, capable of communicating via a network (e.g., the network 110 described below) and/or displaying and navigating Web pages or other types of electronic documents. Although the exemplary system 100 is shown with four user computers, any number of user computers may be supported.

In most embodiments, the system 100 includes some type of network 110. The network can be any type of network familiar to those skilled in the art that can support data communications using any of a variety of commercially-available protocols, including without limitation TCP/IP, SNA, IPX, AppleTalk, and the like. Merely by way of example, the network 110 can be a local area network (“LAN”), such as an Ethernet network, a Token-Ring network and/or the like; a wide-area network; a virtual network, including without limitation a virtual private network (“VPN”); the Internet; an intranet; an extranet; a public switched telephone network (“PSTN”); an infra-red network; a wireless network (e.g., a network operating under any of the IEEE 802.11 suite of protocols, GRPS, GSM, UMTS, EDGE, 2G, 2.5G, 3G, 4G, Wimax, WiFi, CDMA 2000, WCDMA, the Bluetooth protocol known in the art, and/or any other wireless protocol); and/or any combination of these and/or other networks.

The system may also include one or more server computers 102, 104, 106 which can be general purpose computers, specialized server computers (including, merely by way of example, PC servers, UNIX servers, mid-range servers, mainframe computers rack-mounted servers, etc.), server farms, server clusters, or any other appropriate arrangement and/or combination. One or more of the servers (e.g., 106) may be dedicated to running applications, such as a business application, a Web server, application server, etc. Such servers may be used to process requests from user computers 112, 114, 116, 118. The applications can also include any number of applications for controlling access to resources of the servers 102, 104, 106.

The Web server can be running an operating system including any of those discussed above, as well as any commercially-available server operating systems. The Web server can also run any of a variety of server applications and/or mid-tier applications, including HTTP servers, FTP servers, CGI servers, database servers, Java servers, business applications, and the like. The server(s) also may be one or more computers which can be capable of executing programs or scripts in response to the user computers 112, 114, 116, 118. As one example, a server may execute one or more Web applications. The Web application may be implemented as one or more scripts or programs written in any programming language, such as Java®, C, C # or C++, and/or any scripting language, such as Perl, Python, or TCL, as well as combinations of any programming/scripting languages. The server(s) may also include database servers, including without limitation those commercially available from Oracle®, Microsoft®, Sybase®, IBM® and the like, which can process requests from database clients running on a user computer 112, 114, 116, 118.

The system 100 may also include one or more databases 120. The database(s) 120 may reside in a variety of locations. By way of example, a database 120 may reside on a storage medium local to (and/or resident in) one or more of the computers 102, 104, 106, 112, 114, 116, 118. Alternatively, it may be remote from any or all of the computers 102, 104, 106, 112, 114, 116, 118, and/or in communication (e.g., via the network 110) with one or more of these. In a particular set of embodiments, the database 120 may reside in a storage-area network (“SAN”) familiar to those skilled in the art. Similarly, any necessary files for performing the functions attributed to the computers 102, 104, 106, 112, 114, 116, 118 may be stored locally on the respective computer and/or remotely, as appropriate. In one set of embodiments, the database 120 may be a relational database, such as Oracle 10g, that is adapted to store, update, and retrieve data in response to SQL-formatted commands.

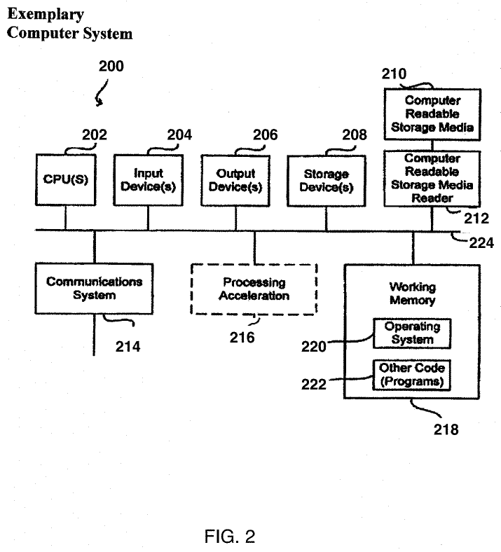

FIG. 2 illustrates an exemplary computer system 200, in which embodiments of the present invention may be implemented. The system 200 may be used to implement any of the computer systems described above. The computer system 200 is shown comprising hardware elements that may be electrically coupled via a bus 224. The hardware elements may include one or more central processing units (CPUs) 202, one or more input devices 204 (e.g., a mouse, a keyboard, etc.), and one or more output devices 206 (e.g., a display device, a printer, etc.). The computer system 200 may also include one or more storage devices 208. By way of example, the storage device(s) 208 can include devices such as disk drives, optical storage devices, solid-state storage device such as a random access memory (“RAM”) and/or a read-only memory (“ROM”), which can be programmable, flash-updateable and/or the like.

The computer system 200 may additionally include a computer-readable storage media reader 212, a communications system 214 (e.g., a modem, a network card (wireless or wired), an infra-red communication device, etc.), and working memory 218, which may include RAM and ROM devices as described above. In some embodiments, the computer system 200 may also include a processing acceleration unit 216, which can include a digital signal processor DSP, a special-purpose processor, and/or the like.

The computer-readable storage media reader 212 can further be connected to a computer-readable storage medium 210, together (and, optionally, in combination with storage device(s) 208) comprehensively representing remote, local, fixed, and/or removable storage devices plus storage media for temporarily and/or more permanently containing, storing, transmitting, and retrieving computer-readable information. The communications system 214 may permit data to be exchanged with the network and/or any other computer described above with respect to the system 200.

The computer system 200 may also comprise software elements, shown as being currently located within a working memory 218, including an operating system 220 and/or other code 222, such as an application program (which may be a client application, Web browser, mid-tier application, RDBMS, etc.). It should be appreciated that alternate embodiments of a computer system 200 may have numerous variations from that described above. For example, customized hardware might also be used and/or particular elements might be implemented in hardware, software (including portable software, such as applets), or both. Further, connection to other computing devices such as network input/output devices may be employed.

Storage media and computer readable media for containing code, or portions of code, can include any appropriate media known or used in the art, including storage media and communication media, such as but not limited to volatile and non-volatile, removable and non-removable media implemented in any method or technology for storage and/or transmission of information such as computer readable instructions, data structures, program modules, or other data, including RAM, ROM, EEPROM, flash memory or other memory technology, CD-ROM, digital versatile disk (DVD) or other optical storage, magnetic cassettes, magnetic tape, magnetic disk storage or other magnetic storage devices, data signals, data transmissions, or any other medium which can be used to store or transmit the desired information and which can be accessed by the computer. Based on the disclosure and teachings provided herein, a person of ordinary skill in the art will appreciate other ways and/or methods to implement the various embodiments.

As discussed above, embodiments are suitable for use with the Internet, which refers to a specific global internetwork of networks. However, it should be understood that other networks can be used instead of the Internet, such as an intranet, an extranet, a virtual private network (VPN), a non-TCP/IP based network, any LAN or WAN or the like.

FIG. 2 further illustrates an environment where an on-demand distributed database service might be used. As illustrated in FIG. 2 user systems might interact via a network with an on-demand database. Some on-demand databases may store information from one or more records stored into tables of one or more distributed database images to form a database management system (DBMS). Accordingly, on-demand database and system will be used interchangeably herein. A database image may include one or more database objects. A relational database management system (RDMS) or the equivalent may execute storage and retrieval of information against the database object(s). Some on-demand database services may include an application platform that enables creation, managing and executing one or more applications developed by the provider of the on-demand database service, wherein users accesses the on-demand database service via user systems, or third party application developers access the on-demand database service via user systems.

The security of a particular user system might be entirely determined by permissions (permission levels) for the current user. For example, where a user account identification transaction may involve a portable identification alpha-numeric data field physically or digitally linked to a personal primary identification device to request services from a provider account and wherein the user is using a particular user system to interact with System, that user system has the permissions allotted to that user account. However, while an administrator is using that user system to interact with System, that user system has the permissions allotted to that administrator. In systems with a hierarchical role model, users at one permission level may have access to applications, data, and database information accessible by a lower permission level user, but may not have access to certain applications, database information, and data accessible by a user at a higher permission level. Thus, different users will have different permissions with regard to accessing and modifying application and database information, depending on a user's security or permission level.

A network can be a LAN (local area network), WAN (wide area network), wireless network, point-to-point network, star network, token ring network, hub network, or other appropriate configuration. As the most common type of network in current use is a TCP/IP (Transfer Control Protocol and Internet Protocol) network such as the global internetwork of networks often referred to as the “Internet” with a capital “I,” that will be used in many of the examples herein. However, it should be understood that the networks that the present invention might use are not so limited, although TCP/IP is a frequently implemented protocol.

User systems might communicate with a system using TCP/IP and, at a higher network level, use other common Internet protocols to communicate, such as HTTP, FTP, AFS, WAP, etc. In an example where HTTP is used, a user system might include an HTTP client commonly referred to as a “browser” for sending and receiving HTTP messages to and from an HTTP server at System. Such HTTP server might be implemented as the sole network interface between a system and network, but other techniques might be used as well or instead. In some implementations, the interface between a system and network includes load sharing functionality, such as round-robin HTTP request distributors to balance loads and distribute incoming HTTP requests evenly over a plurality of servers. At least as for the users that are accessing that server, each of the plurality of servers has access to at least one third party entity system data schema; however, other alternative configurations are contemplated.

According to one arrangement, each user system and all of its components are operator configurable using applications, such as a browser, including computer code run using a central processing unit such as an Intel Pentium® processor or the like. Similarly, a computer system (and additional instances of an enterprise database, where more than one is present) and all of their components might be operator configurable using application(s) including computer code run using a central processing unit such as an Intel Pentium® processor or the like, or multiple processor units. A computer program product aspect includes a machine-readable storage medium (media) having instructions stored thereon/in which can be used to program a computer to perform any of the processes of the embodiments described herein. Computer code for operating and configuring systems to intercommunicate and to process web pages, applications and other data and media content as described herein is preferably downloaded and stored on a hard disk, but the entire program code, or portions thereof, may also be locally stored in any other volatile or non-volatile memory medium or device as is well known, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory ICs), or any type of media or device suitable for storing instructions and/or data.

Additionally, the entire program code, or portions thereof, may be transmitted and downloaded from a software source over a transmission medium, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for implementing aspects of the present invention can be implemented in any programming language that can be executed on a client system and/or server or server system such as, for example, in C, C++, HTML, any other markup language, Java™, JavaScript, ActiveX, any other scripting language such as VBScript, and many other programming languages as are well known. (Java™ is a trademark of Sun Microsystems, Inc.).

The above illustrations provide many different embodiments for implementing different features of the invention. Specific embodiments of components and processes are described to help clarify the invention. These are, of course, merely embodiments and are not intended to limit the invention from that described in the claims.

Persons of ordinary skill in the art will realize that the foregoing description is illustrative only and not in any way limiting. Other modifications and improvements will readily suggest themselves to such skilled persons having the benefit of this disclosure.

While embodiments and applications of this disclosure have been shown and described, it would be apparent to those skilled in the art that many more modifications and improvements than mentioned above are possible without departing from the inventive concepts herein. The disclosure, therefore, is not to be restricted except in the spirit of the appended claims.

1. A secure ledger network for prosecuting patent applications, the secure ledger network comprising:
At least one hardware processor, a non-transitory machine-readable storage medium having an executable computer readable program code, the at least one hardware processor configured to execute the computer-readable program code to:
receive, by the secure ledger network, a request to validate a smart contract that determines at least one rule for categorizing patent prior art;
receiving, by the secure ledger network, a request to compare at least one patent application with prior art based on category;
validating the request;
updating a secure ledger maintained by the secure ledger network with the request;
executing a smart contract;
updating the secure ledger about the transaction;
transferring the prior art publication to at least one user.

2. The network of claim 1, wherein the smart contract contains a rule to compare a patent application with prior art submitted by the at least one user.

3. The network of claim 1, where the at least one user is identified by a unique address.

4. The network of claim 1, wherein the rule for categorizing patent prior art is defined by input from at least one other user.

5. The secure ledger network of claim 1, wherein the at least one user is a law firm.

6. The secure ledger network of claim 1, wherein the at least one user is an inventor.

7. The secure ledger network of claim 1, wherein the at least one user is a patent examiner.

8. A system comprising a plurality of nodes, each node configured to transact with at least one other node in the plurality of nodes, the system comprising:
At least one hardware processor, a non-transitory machine-readable storage medium having an executable computer readable program code, the at least one hardware processor configured to execute the computer-readable program.
The system further configured to:
Provide information regarding at least one law firm, the information further categorized to include a field of specialty and country of operation;
Allow at least one user to provide feedback on the at least one law firm.

9. The system of claim 8, further configured to validate the existence of contractual dealing between the at least one user and the at the at least one law firm.

10. A method for identifying patent related publications, the method comprising:
A user search enabled distributed network, the network comprising:
a plurality of nodes, wherein each node in the plurality of nodes is configured to transact autonomously with at least two nodes in the plurality of nodes and configured to communicate with at least one server;
at least one server, the at least one server comprising at least one hardware processor, a non-transitory machine-readable storage medium having an executable computer readable program code, the at least one hardware processor configured to execute the computer-readable program code;
the server, capable of identifying at least one user using a private key and a public key and connected to an at least one user device;
the user device capable of communicating with the plurality of nodes;
the computer readable program code, configured to distinguish prior art related to a patent application;
the computer readable code further configured to provide a user with information regarding the prior art;
the computer readable code further configured to provide information regarding the success of at least one law firm in prosecuting patents in the same jurisdiction.

11. The method of claim 10, wherein the prior art publications are from at least two different countries.

12. The network of claim 10, wherein the network automatically verifies the success rate of prosecution of the at least one law firm.

13. The network of claim 10, wherein the user is a patent examiner.

14. The network of claim 10, wherein the user is an inventor.

15. The network of claim 10, wherein the user is any interested party.

16. The network of claim 10, wherein the patent related publications are prior art.

17. The network of claim 10, wherein the patent related publications are any global description of the embodiment of a patent.

18. The network of claim 10, wherein the patent related publications are any global description of the embodiment of a patent application.

19. The network of claim 10, wherein the patent related publications are patents or patent applications.

20. The network of claim 10, wherein the patent related publications are non-patent literature (NPL).
